(19) United States
(12) Patent Application Publication
(10) Pub. No.: US 2017/0252590 A1
(43) Pub. Date: Sep. 7, 2017

(54) Respirator Having Corrugated Filtering Structure

(71) Applicant: 3M INNOVATIVE PROPERTIES COMPANY, St. Paul, MN (US)

(72) Inventors: Seyed A. Angadjivand, Los Angeles, CA (US); Nhat Ha T. Nguyen, Woodbury, MN (US); Bryan L. Gerhardt, Woodbury, MN (US); Jimmy M. Le, St. Paul, MN (US); John M. Brandner, St. Paul, MN (US); Stephen M. Sanocki, Hudson, WI (US)

(21) Appl. No.: 15/519,888

(22) PCT Filed: Oct. 21, 2015
(86) PCT No.: PCT/US2015/056594

§ 371 Date: Apr. 18, 2017

Related U.S. Application Data
(60) Provisional application No. 62/073,067, filed on Oct. 31, 2014.

(51) Int. Cl. A62B 23/02; A41D 13/11

(52) U.S. Cl. CPC A62B 23/025; A41D 13/1115

(57) ABSTRACT

Various embodiments of a filtering face-piece respirator and a method of making such respirator are disclosed. In one or more embodiments, the filtering face-piece respirator includes a mask body and a harness attached to the mask body. The mask body includes a corrugated filtering structure including peaks separated by valleys, and bridging filaments that are in discontinuous contact with at least one of an interior surface and an exterior surface of the corrugated filtering structure. The bridging filaments are attached to at least some of the peaks.

### BACKGROUND

Respirators are commonly worn over a person's breathing passages in at least one of two situations: (1) to prevent impurities or contaminants from entering the wearer's respiratory system; and (2) to protect other persons or things from being exposed to pathogens and other contaminants exhaled by the wearer. In the first situation, the respirator is worn in an environment where the air contains particles that may be harmful to the wearer, for example, in an auto body shop. In the second situation, the respirator is worn in an environment where there is risk of contamination to other persons or things, for example, in an operating room or clean room.

A variety of respirators have been designed to be used in one or both of these situations. Some of these respirators have been categorized as being “filtering face-pieces” because the mask body itself functions as the filtering mechanism. Unlike respirators that use rubber or elastomeric mask bodies with attachable filter cartridges (see, e.g., U.S. Pat. No. RE39,493 to Yuschak et al.) or insert-molded filter elements (see, e.g., U.S. Pat. No. 4,790,306 to Braun), filtering face-piece respirators are designed to have the filter media cover much of the mask body so that there is no need for installing or replacing a filter cartridge. These filtering face-piece respirators commonly come in one of two configurations: molded respirators and flat-fold respirators.

Molded filtering face-piece respirators often include non-woven webs of thermally-bonded fibers or open-work plastic meshes to furnish the mask body with its cup-shaped configuration. Molded respirators tend to maintain the same shape during both use and storage. These respirators, therefore, cannot be folded flat for storage and shipping. Examples of patents that disclose molded, filtering, face-piece respirators include U.S. Pat. No. 7,131,442 to Kronzer et al; U.S. Pat. Nos. 6,923,182 and 6,041,782 to Angadjivand et al.; U.S. Pat. No. 4,807,619 to Dyrud et al.; and U.S. Pat. No. 4,536,440 to Berg.

Flat-fold respirators, as the name implies, can be folded flat for shipping and storage. Such respirators can be opened into a cup-shaped configuration for use. Examples of flat-fold respirators are described in U.S. Pat. Nos. 6,568,392 and 6,484,722 to Bostock et al.; and U.S. Pat. No. 6,394,090 to Chen. Some flat-fold respirators have been designed with weld lines, seams, and folds to help maintain their cup-shaped configuration during use. Stiffening members also have been incorporated into panels of the mask body. See, e.g., U.S. Patent Publication Nos. 2001/0067700 and 2010/0154805 to Duffy et al.; and U.S. Design Pat. No. 659,821 to Spoo et al.

Flat-fold respirators have two general orientations when folded flat for storage. In one configuration—sometimes referred to as a “horizontal” flat-fold respirator—the mask body is folded crosswise such that it has an upper portion and a lower portion. A second type of respirator is referred to as a “vertical” flat-fold respirator because the primary fold is oriented vertically when the respirator is viewed from the front in an upright position. Vertical flat-fold respirators have left and right portions on opposing sides of the vertical fold or a centerline of the mask body.

Filtering face-piece respirators of the kinds described typically include several different components that are joined or assembled together to make an integral unit. These components may include harnesses, exhalation valves, face seals, nose clips, and the like. For example, face seal components are regularly added because they provide a comfortable fit between differing contours of a wearer's face and the respirator mask body and also to accommodate dynamic changes that might render the seal ineffective, such as when a wearer's face is moving while the wearer is speaking.

### SUMMARY

In general, the present disclosure provides various embodiments of a respirator that includes a corrugated filtering structure and one or more bridging filaments disposed on one or both major surfaces of the corrugated filtering structure.

In one aspect, the present disclosure provides a filtering face-piece respirator that includes a mask body and a harness attached to the mask body. The mask body includes a corrugated filtering structure including peaks separated by valleys, and elastic bridging filaments that are in discontinuous contact with at least one of an interior surface and an exterior surface of the corrugated filtering structure. The elastic bridging filaments are attached to at least some of the peaks.

In another aspect, the present disclosure provides a method of making a respirator that includes a mask body. The method includes forming a filtering structure, corrugating the filtering structure such that the filtering structure includes peaks separated by valleys, and forming the corrugated filtering structure into a cup-shaped configuration to form the mask body. The method further includes attaching elastic bridging filaments to at least some of the peaks of the corrugated filtering structure such that the elastic bridging filaments are in discontinuous contact with at least one of an interior surface and an exterior surface of the corrugated filtering structure, and attaching a harness to the mask body.

All headings provided herein are for the convenience of the reader and should not be used to limit the meaning of any text that follows the heading, unless so specified.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements. The term “consisting of” means “including,” and is limited to whatever follows the phrase “consisting of” Thus, the phrase “consisting of” indicates that the listed elements are required or mandatory and that no other elements may be present. The term “consisting essentially of” means including any elements listed after the phrase, and is limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to embodiments of the disclosure that may afford certain benefits, under certain circumstances; however, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

### Glossary

The terms set forth herein will have the meanings as defined:

“bridging filament” means a filament, or collection of strands that form a filament, that extends between, and is bonded to, at least two peaks of a filtering structure; alternatively, a “bridging filament” means a filament that is bonded to and/or entangled with other filaments so that the filaments collectively bridge the distance between at least two peaks of the filtering structure;

“clean air” means a volume of atmospheric ambient air that has been filtered to remove contaminants;

“compressible” means that one or more peaks or valleys of a filtering structure can reversibly compress when moderate force is applied to the peaks or valleys, and that the peaks and valleys can spring back to their original configuration when the force is removed;

“contaminants” means particles (including dusts, mists, and fumes) and/or other substances that generally may not be considered to be particles (e.g., organic vapors, etc.) but which may be suspended in air;

“crosswise dimension” is the dimension that extends laterally across the respirator, from side-to-side when the respirator is viewed from the front;

“cup-shaped configuration” and variations thereof mean any vessel-type shape that is capable of adequately covering the nose and mouth of a person;

“cushioning member” and variations thereof mean a compressible material that does not include the filter media or the filtering structure;

“discontinuous contact” means that a first portion of a bridging filament is in contact with a filtering structure and a second portion of the bridging filament is not in contact with the filtering structure;

“exterior gas space” means the ambient atmospheric gas space into which exhaled gas enters after passing through and beyond the mask body and/or exhalation valve;

“exterior surface” means the surface of the mask body exposed to ambient atmospheric gas space when the mask body is positioned on the person's face;

“filtering face-piece” means that the mask body itself is designed to filter air that passes through it; there are no separately identifiable filter cartridges or insert-molded filter elements attached to or molded into the mask body to achieve this purpose;

“filter” or “filtering structure” means one or more layers of air-permeable material, which layer(s) is adapted for the primary purpose of removing contaminants (such as particles) from an air stream that passes through it;

“harness” means a structure or combination of parts that assists in supporting the mask body on a wearer's face;

“interior gas space” means the space between a mask body and a person's face;

“interior surface” means the surface of the mask body closest to a person's face when the mask body is positioned on the person's face;

“mask body” means an air-permeable structure that is designed to fit over the nose and mouth of a person and that helps define an interior gas space separated from an exterior gas space (including the seams and bonds that join layers and parts thereof together);

“nose clip” means a mechanical device (other than a nose foam), which device is adapted for use on a mask body to improve the seal at least around a wearer's nose;

“nose region” means the portion of the mask body that resides over a wearer's nose when the respirator is worn;

“peak axis” means an axis along which most peaks of a corrugated filtering structure are aligned as illustrated in FIG. 2;

“perimeter” means the outer edge of the mask body, which outer edge would be disposed generally proximate to a wearer's face when the respirator is being donned by a person; a “perimeter segment” is a portion of the perimeter;

“pleat” means a portion that is designed to be or is folded back upon itself;

“polymeric” and “plastic” each means a material that mainly includes one or more polymers and that may contain other ingredients as well;

“respirator” means an air filtration device that is worn by a person to provide the wearer with clean air to breathe;

“sinus region” means the nose region and parts or areas of the mask body that reside beneath the wearer's eyes and/or eye orbitals when the respirator is being worn in a proper configuration;

“snug fit” or “fit snugly” means that an essentially air-tight (or substantially leak-free) fit is provided (between the mask body and the wearer's face); and

“transversely extending” means extending generally in the crosswise dimension.

These and other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is a schematic front view of one embodiment of a respirator.

FIG. 2 is a schematic perspective view of a filtering structure of the respirator of FIG. 1 in a flat configuration.

FIG. 3 is a schematic cross-section view of a portion of the filtering structure of FIG. 2.

FIG. 4 is a schematic cross-section view of a portion of one embodiment of a filtering structure.

FIG. 5 is a schematic front view of another embodiment of a respirator.

FIG. 6 is a schematic perspective view of another embodiment of a respirator.

FIG. 7 is a diagrammatic view of one embodiment of an apparatus for making a respirator.

FIG. 8 is a graph of percent penetration and pressure drop (mm H₂O) versus NIOSH NaCl exposure (mg).

### DETAILED DESCRIPTION

In general, the present disclosure provides various embodiments of a respirator that includes a corrugated filtering structure and one or more bridging filaments disposed on one or both major surfaces of the corrugated filtering structure. In one or more embodiments, the corrugated filtering structure includes peaks separated by valleys. The bridging filaments can be in discontinuous contact with at least one of the major surfaces of the corrugated filtering structure. In one or more embodiments, the bridging filaments can be attached to at least some of the peaks of the corrugated filtering structure.

In one or more embodiments, the filtering structure can be formed by passing one or more flat filtering structures through a corrugating process that imparts structure into the filtering structure. The imparted structure can be held in place by disposing one or more bridging filaments onto at least one major surface of the filtering structure, thereby forming a self-supporting structure. This self-supporting structure can be compressible and moldable. Such structures can be used as filtering structures in a respirator, e.g., a flat-fold, cup-shaped, reusable respirator.

The filtering structures of the present disclosure can be utilized in any suitable type of respirator. For example, the filtering structures can be included in a filtering face-piece respirator. Further, in one or more embodiments, the disclosed filtering structures can be utilized in any suitable type of filtering face-piece respirator, e.g., a molded respirator, a flat-fold respirator, etc.

A corrugated filtering structure can, in general, provide greater surface area and, therefore, reduced breathing resistance while improving filter efficiency. Such corrugated filtering structures can act as gradient filters. Further, webs having increased loft can be used in these corrugated configurations. Such webs can increase service life of the respirator and also increase confortability to a wearer because of the cushioning effect of the increased loft. Further, such corrugated filtering structures can be molded or shaped into a variety of configurations. And, in or more embodiments, the corrugated filtering structure can allow the respirator to expand while the wearer is talking or moving without sacrificing the fit of the respirator.

Filtration parameters such as pressure drop and service life can be negatively affected when a corrugated filtering structure is compacted or collapsed. One or more embodiments of the present disclosure can provide a respirator that maintains its corrugated shape.

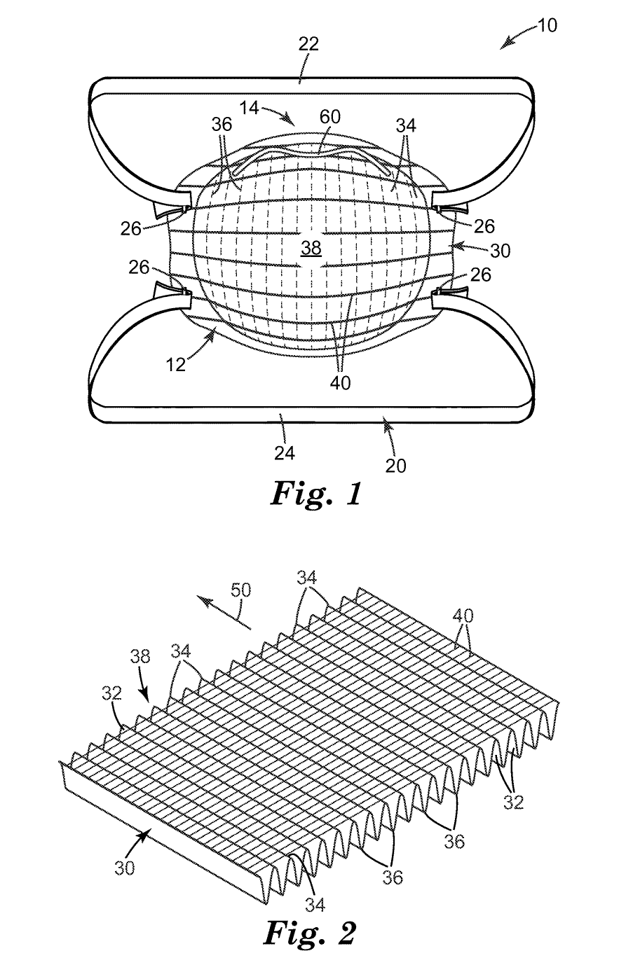

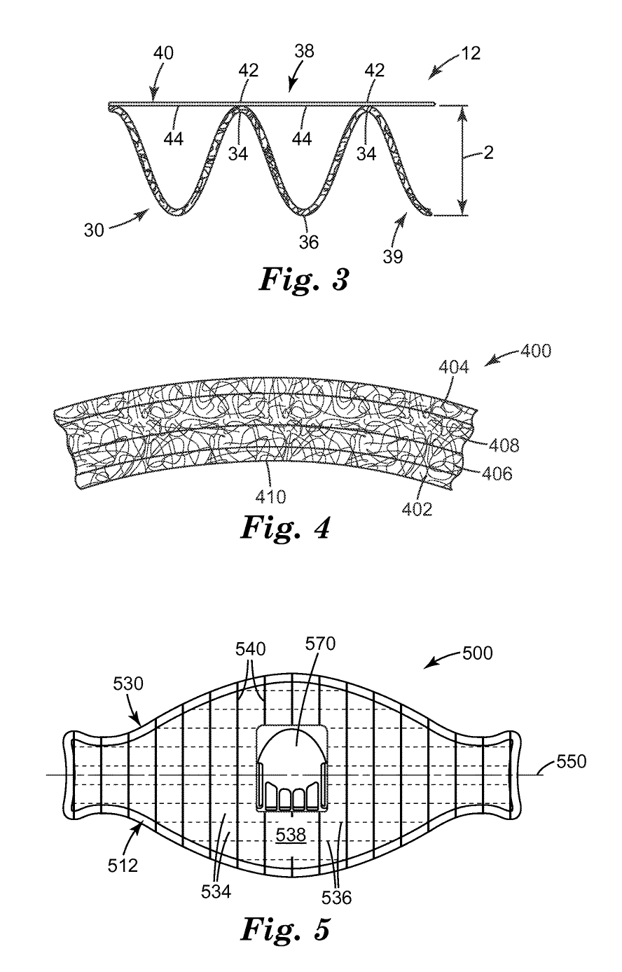

For example, FIG. 1 is a schematic front view of one embodiment of a respirator 10. The respirator includes a mask body 12 and a harness 20 attached to the mask body. Mask body 12 includes a filtering structure 30. In one or more embodiments, the filtering structure 30 can be a corrugated filtering structure that includes peaks 34 separated by valleys 36. The mask body 12 can also include one or more bridging filaments 40 that are in discontinuous contact with at least one major surface of the filtering structure. For example, in one or more embodiments, the bridging filaments 40 can be in discontinuous contact with at least one of an interior surface (as shown in FIG. 3) and an exterior surface 38 of the filtering structure. In one or more embodiments, the bridging filaments 40 can be attached to at least some of the peaks 34 of the filtering structure.

Attached to the mask body 12 is the harness 20, which can include any suitable harness that can hold the mask body in place on a face of a wearer. As illustrated in FIG. 1, the harness 20 includes a first (i.e., upper) strap 22 a second (i.e., lower) strap 24 that are attached to the mask body 12 at attachment locations 26. The first and second straps 22, 24 can be attached to the mask body 12 at any suitable location or locations. For example, in the illustrated embodiment, the first and second straps 22, 24 are attached to the outer surface 38 of the filtering structure 30 of mask body 12. In one or more alternative embodiments, the first and second straps 22, 24 can be attached to an inner surface of the filtering structure 30 of the mask body 12.

The first and second straps 22, 24 can be attached to the mask body 12 using any suitable technique or combination of techniques, e.g., thermal bonding, ultrasonic welding, adhering (e.g., using glues, adhesives, hot-melt adhesives, pressure sensitive adhesives, etc.), or mechanical fastening (e.g., using buckles, buttons and hooks, mating surface fasteners, or openings, such as loops or slots, formed at the left or right attachment locations for entrapping the strap material, etc.). The first and second straps 22, 24 can be attached to the mask body 12 such that the forces acting between the harness 20 and the mask body 12 when being worn by a wearer are in a peel mode or in a sheer mode. The harness 20 may be attached to the mask body 12 between layers of the filtering structure 30 or on either outer or inner surface of the filtering structure.

In general, the strap(s) that are used in the respirator harness can be expanded to greater than twice its total length and can be returned to its relaxed state many times throughout the useful life of the respirator. The strap also could possibly be increased to three or four times its relaxed state length and can be returned to its original condition without any damage thereto when the tensile forces are removed. In one or more embodiments, the elastic limit thus is not less than two, three, or four times the relaxed-state length of the strap(s). Typically, the strap(s) are about 20 to 32 cm long, 3 to 20 mm wide, and about 0.3 to 1 mm thick. The strap(s) may extend from the first side of the respirator to the second side as a continuous strap, or the strap may have a plurality of parts, which can be joined together by further fasteners or buckles. For example, the strap may have first and second parts that are joined together by a fastener that can be quickly uncoupled by the wearer when removing the mask body from the face. Alternatively, the strap may form a loop that is placed around the wearer's ears. See, e.g., U.S. Pat. No. 6,394,090 to Chen et al. Examples of fastening or clasping mechanisms that may be used to join one or more parts of the strap together are shown, e.g., in U.S. Pat. No. 6,062,221 to Brostrom et al. and U.S. Pat. No. 5,237,986 to Seppala; and in EP Patent Publication No. 1,495,785A1 to Chen. The harness may also include a reusable carriage, one or more buckles, and/or a crown member to support the respirator on a person's head. See, e.g., U.S. Pat. Nos. 6,732,733 and 6,457,473 to Brostrom et al.; and U.S. Pat. Nos. 6,591,837 and 6,715,490 to Byram.

In one or more embodiments, the respirator 10 can also include a nose clip 60 disposed adjacent a nose region 14 of the mask body 12. As used herein, the phrase “adjacent a nose region” means that an element or device is disposed closer to the nose region 14 of the mask body 12 than to a central region of the mask body. Any suitable nose clip 60 can be utilized. In one or more embodiments, the nose clip 60 may be essentially any additional part that assists in improving the fit over the wearer's nose. Because the wearer's face exhibits a major change in contour in the nose region, a nose clip may be used to better assist in achieving the appropriate fit in this location. The nose clip 60 may include, for example, a pliable dead soft band of metal such as aluminum, which can be shaped to hold the mask in a desired fitting relationship over the nose of the wearer and where the nose meets the cheek. The nose clip 60 may be linear in shape when viewed from a plane projected onto the mask body when in its folded or partially folded condition. Alternatively, the nose clip can be an M-shaped nose clip as is illustrated in FIG. 1. See, e.g., U.S. Pat. No. 5,558,089 and Des. 412,573 to Castiglione. Other exemplary nose clips are described in U.S. Pat. No. 8,066,006 to Daigard et al.; U.S. Pat. No. 8,171,933 to Xue et al.; and U.S. Patent Publication No. 2007-0068529A1 to Kalatoor et al.

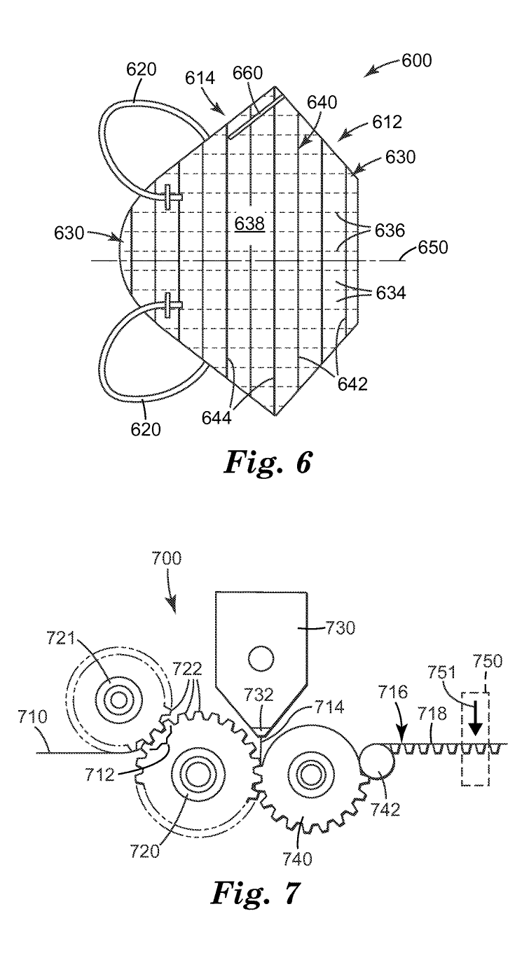

The mask body 12 can include any suitable mask body. For example, the mask body 12 can form a molded filtering face-piece respirator as illustrated in FIG. 1. Alternatively, in one or more embodiments, the mask body 12 can form a flat fold respirator as shown in FIGS. 5-6 and further described herein. In one or more embodiments, the mask body 12 can be formed such that it does not include any permanently deformable layer or member that is corrugated along with the corrugated filtering structure 30 so as to be in generally continuous contact with the corrugated filtering structure.

The respirator 10 can include any suitable filtering structure 30. For example, FIG. 2 is a schematic perspective view of a portion of the filtering structure 30 of FIG. 1 in an un-molded or flat configuration for illustrative purposes only. As shown in FIG. 2, the filtering structure 30 includes peaks 34 that are, in one or more embodiments, oriented in a generally parallel relation to each other along a peak axis 50. The peaks 34 are separated by valleys 36. As shown in FIG. 2, the peaks 34 form the exterior surface 38 of the filtering structure 30 illustrated in FIG. 2. In one or more embodiments, the peaks 34 would instead appear as valleys 36 when viewed from the opposing major surface of the filtering structure, i.e., the valleys 36 become peaks and the peaks become valleys when viewed from the opposing major surface of the filtering structure not shown in FIG. 2. The peaks 34 and valleys 36 are connected by walls 32 that extend from the peaks to the valleys.

The filtering structure 30 can take any suitable shape or combination of shapes. In one or more embodiments, the filtering structure 30 can take a sinusoidal shape in cross-section as shown in FIG. 3. The peaks and valleys 34, 36 can include any suitable average radius of curvature as measured when the filtering structure 30 is in a flat configuration as shown in FIG. 2. In one or more embodiments, the average radius of curvature of one or both of the peaks and valleys 34, 36 can be at least 2 mm. In one or more embodiments, the average radius of curvature of one or both of the peaks and valleys 34, 36 can be no greater than 1.5 cm. The filtering structure 30 can include peaks 34 that have substantially the same shape. Alternatively, the peaks 34 can include a first set of peaks having a first shape and a second set of peaks having a second shape different from the first shape. Further, the filtering structure 30 can include valleys 36 that have substantially the same shape. In one or more alternative embodiments, the valleys 36 can include a first set of valleys having a first shape and a second set of valleys having a second shape different from the first shape. In one or more embodiments, the filtering structure 30 can include peaks 34 of varying shapes and/or valleys 36 of varying shapes.

The corrugated filtering structure 30 can include any suitable peak frequency, i.e., the number of peaks per unit length measured in a direction orthogonal to the peak axis 50. In one or more embodiments, the filtering structure 30 can include a peak frequency of greater than 0 peaks per cm. In one or more embodiments, the filtering structure 30 can include a peak frequency of no greater than 3 peaks per cm.

Further, the filtering structure 30 can include any suitable size of peaks 34 and valleys 36. In one or more embodiments, the filtering structure 30 can include an average peak height of greater than 0 mm. In one or more embodiments, the filtering structure 30 can include an average peak height of no greater than 20 mm. The peak height is defined as a distance from a valley 36 to an adjacent peak 34 of the filtering structure 30 in a thickness direction of the filtering structure. For example, the peak height 2 is shown in FIG. 3, which is a schematic cross-section view of a portion of the filtering structure 30 of FIGS. 1-2.

The filtering structure 30 can include any suitable layer or layers. For example, in one or more embodiments, the filtering structure 30 can include at least one of an inner cover layer, an outer cover layer, a filtering structure, and a shaping layer as is further described herein.

The mask body 12 further includes bridging filaments 40. Any suitable number of bridging filaments 40 can be included with mask body 12. The bridging filaments 40 can be in contact with one or both of the peaks 34 and valleys 36. In one or more embodiments, the bridging filaments 40 can be in discontinuous contact with at least one of the major surfaces of the mask body 12, i.e., one or both of the exterior surface 38 and the interior surface 39 (as shown in FIG. 3). In one or more embodiments, bridging filaments 40 can be collectively supplied by, e.g., filaments of a spun-bonded web (scrim or netting), which filaments, even if they are too short and/or are oriented so that they do not extend between peaks 34, are bonded to other filaments so as to collectively bridge the distance between the peaks 34 (with the filament portions that are in contact with the peaks being bonded thereto). In one or more embodiments, bridging filaments 40 can be collectively supplied, e.g., by filaments of an expanded metal (such as, e.g., the products available from Wallner Tooling/Expac, Rancho Cucamonga, Calif.), even though individual segments of the metal filaments (between junction points with other individual segments) may (or may not) be long enough to extend between two peaks 34. In one or more embodiments, bridging filaments 40 can include an average length that is at least 100%, 200%, 400%, or 800% of the spacing between consecutive peaks 34, and/or will be arranged so that at least some individual filaments extend between, and are bonded to, at least two peaks of the corrugated filtering structure 30.

Further, in one or more embodiments, most portions of most filaments 40 are spaced away from a majority of the area of walls 32 between peaks 34 and valleys 36. In other words, the bridging filaments 40 are spaced apart from the walls 32 except for portions of the walls near, or very close to, the peaks 34 and/or valleys 36. For example, as shown in FIG. 3, first portions 42 of bridging filament 40 are in contact with filtering structure 30 at peaks 34, while second portions 44 of the bridging filament are not in contact with the filtering structure. The first portions 42 of bridging filament 40 can be in contact with any suitable portion of the filtering structure 30 at or adjacent peaks 34. As used herein, the phrase “adjacent the peaks” means portions of the filtering structure that are closer to the peaks than to the valleys 36. Bridging filaments 40 are, therefore, in discontinuous contact with the exterior surface 38 of the corrugated filtering structure 30.

In one or more embodiments, at least some bridging filaments 40 may be oriented at least substantially perpendicular to (i.e., within +/−about 10 degrees of) the peak axis 50 of corrugated filtering structure 30. In such embodiments, a bridging filament 40 may extend between, and be bonded to, any suitable number of peaks 34, e.g., two, three, four, eight, or more peaks. In one or more embodiments, at least some bridging filaments 40 may be continuous, meaning that they extend along the entire length of the corrugated filtering structure 30. Such continuous bridging filaments 40 thus will not be severed or otherwise made discontinuous anywhere along the entire length or width of the corrugated filtering structure 30. In any case, a bridging filament 40 (continuous or not) will be distinguished from filaments that are cut or otherwise made so short that they do not extend between at least two peaks 34. In one or more embodiments, bridging filaments 40 are at least generally straight. In embodiments of this type, at least some of the bridging filaments 40 may be at least generally parallel to each other shown in FIG. 2; however, other arrangements are possible, as discussed herein.

The bridging filaments 40 can be disposed at any suitable angle relative to the peak axis 50. In one or more embodiments, at least some of the bridging filaments are disposed at an angle of greater than 0° to the peak axis 50. In one or more embodiments, at least some of the bridging filaments 40 are disposed at an angle of no greater than 90° to the peak axis 50.

Bridging filaments 40 can locally stabilize corrugated filtering structure 30 to minimize any local deformation of a peak 34 due to the pressure of an airstream impinging on exterior surface 38 and/or the interior surface of the filtering structure. It will thus be appreciated that bridging filaments 40 can act to locally stabilize corrugated filtering structure 40.

Bridging filaments 40 can include any material or combination of materials as long as the material, in combination with the dimensions (e.g., width, thickness) of the filament, provides the desired combination of physical properties (e.g., flexibility and inextensibility). Such materials may include organic polymeric materials (whether naturally occurring or synthetic, including those already mentioned herein), inorganic materials (e.g., fiberglass), and so on. In one or more embodiments, bridging filaments 40 are not made of metal or of inorganic materials such as fiberglass; in further embodiments, filtering structure 30 does not include any sort of supporting member, sheet or layer that includes any metal or inorganic material.

In one or more embodiments, bridging filaments 40 may be non-elastic. Non-elastic as defined herein encompasses any material that does not have a relatively high reversible extensibility (characterized, e.g., by the ability to be reversibly elongated to, e.g., 100% or more without undergoing plastic deformation) characteristic of elastic materials such as natural rubber, SBR rubber, lycra, etc. Thus, common polymeric materials, e.g., extrudable materials (including but not limited to, e.g., polypropylene, poly(lactic acid), polyethylene terephthalate and the like), may be used to form bridging filaments 40.

In one or more embodiments, filaments 40 may be made of an elastic material. In one or more embodiments, such elastic bridging filaments 40 may extend or elongate to any significant extent (e.g., more than about 10%) and retract under the forces present upon the mask body 12. Elastic bridging filaments can include any suitable elastic material, e.g., polypropylene, polystyrene, polyethylene, polyurethane, SEBS, SEPS, SBPS, metallocene, KRATON, carbon, and combinations thereof. In one or more embodiments, bridging filaments 40 as disclosed herein are flexible, meaning that filaments can (individually and collectively) be easily and reversibly bent, curved, rolled up etc.

In one or more embodiments, one or more of the bridging filaments 40 can include a layer or layers of additional material on an outer surface of the filament. For example, in one or more embodiments, one or more bridging filaments 40 can include a carbon layer coated onto an outer surface of the filaments.

In one or more embodiments, bridging filaments 40 may be individual filaments that are individually provided (e.g., polymeric filaments that are disposed onto the corrugated filtering structure 30 as described later herein). In one or more embodiments, bridging filaments 40 may be provided as filaments of a scrim or netting. In this context, the term scrim is used to broadly encompass any collection of filaments that are in contact with each other, achieved by any technique or combination of techniques. Specifically, the term scrim is not limited to organic polymeric materials but rather includes metal meshes or netting (e.g., expanded metals as mentioned earlier herein), inorganic scrims made of, e.g., fiberglass, and so on. In one or more embodiments, such a scrim or netting may be a pre-existing scrim or netting, meaning a scrim or netting that has been pre-made and that has sufficient mechanical integrity to be handled, and brought into contact with the upstream pleat tips, as a unit.

The bridging filaments 40 can further include any suitable construction. In one or more embodiments, the bridging filaments 40 can include one or more bicomponent filaments, e.g., core/sheath filaments. In such filaments, the core can include a first material and the sheath can include a second material. The first material can be the same as or different from the second material. In one or more embodiments, the bridging filaments 40 can include one or more hollow filaments.

In one or more embodiments, bridging filaments 40 may include an average diameter (or equivalent diameter in the case of filaments with a non-circular or irregular cross-section) of at most about 2, 1, 0.5, 0.2, or 0.1 mm. In further embodiments, filaments 40 may include an average diameter or equivalent diameter of at least about 0.05, 0.10, 0.20, or 0.25 mm. Filaments 40 may include any suitable shape when viewed in cross section, (e.g., generally round, square, oblong, etc.).

Filaments 40 can include any suitable spacings between individual filaments as desired. The average filament spacing is the average distance between two adjacent bridging filaments as measured for the entire mask body 12. In one or more embodiments, an average filament spacing can be at least about 0 mm, at least about 2 mm, at least about 4 mm, or at least about 6 mm. In one or more embodiments, the average filament spacing can be at most about 60 mm, at most about 40 mm, at most about 20 mm, at most about 15 mm, at most about 10 mm, or at most about 8 mm. The filament spacings can be relatively constant or can be varied. Some inherent variation in filament spacing may occur in production and handling of filaments. Regardless of the specific arrangements, a suitable set of filaments 40 will collectively include a highly open structure (in various embodiments, comprising greater than at least 80, 90, or 95% open area) so as to allow sufficient airflow through corrugated filtering structure 30.

In one or more embodiments, bridging filaments 40 (e.g., for a netting or scrim) may include at least some filaments that are oriented generally perpendicular to the peak axis 50 and that are parallel to each other (e.g., that are oriented in similar manner to the filaments 40 of FIG. 2), with other filaments also present (that may or may not be bridging filaments) and which other filaments may be oriented in various directions. In one or more embodiments, a collection of bridging filaments 40 may be provided in the form of plastic mesh or netting, a knit or woven fabric, and so on (noting, however, that any such material does not necessarily have to be bonded to the pleated filter media so that a set of filaments of the material is strictly, or even generally, perpendicular to the pleat direction). See, e.g., U.S. Patent Application No. 62/038,455 to Nguyen et al. (Atty Docket No. 75351US002).

In one or more embodiments, rather than filaments 40 being provided that are oriented at least generally perpendicular to the peak axis 50, filaments may be provided at a wide variety of orientations and spacings. Such filaments 40 may follow curves, loops, tortuous paths, and so on.

In one or more embodiments, bridging filaments 40 may be provided as part of a scrim or netting that includes a collection of randomly-oriented filaments, as long as such filaments are sufficiently long and are bonded and/or entangled with each other to serve as bridging filaments as defined herein. Such a scrim might be, e.g., a spun-bonded web, spun-laced web, a carded web, a Rando web, a laminate of multiple webs, and so on.

In one or more embodiments, bridging filaments 40 may be disposed on both the exterior surface 38 and the interior surface 39. Any suitable bridging filaments may be included on the interior surface 39 of the mask body 12, e.g., the same bridging filaments disposed on the exterior surface 38. In one or more embodiments, the bridging filaments 40 on the exterior surface 38 may be different from the bridging filaments disposed on the interior surface 39 of the filtering structure 30. In one or more embodiments, the bridging filaments 40 on the exterior surface 38 may be disposed in an arrangement that is the same as an arrangement of bridging filaments disposed on the interior surface 39 of the filtering structure 30. In one or more embodiments, the bridging filaments 40 disposed on the exterior surface 38 may be arranged in a different pattern from the arrangement of bridging filaments disposed on the interior surface 39.

The bridging filaments 40 may be disposed on the exterior surface 38 or the interior surface 39 of the filtering structure 30 in any suitable pattern. For example, in one or more embodiments, the bridging filaments 40 may be disposed such that each filament is substantially perpendicular to the peak axis 50. In other words, in one or more embodiments, the bridging filaments 40 can be disposed such that individual filaments form straight lines. In one or more alternative embodiments, one or more bridging filaments 40 can be disposed such they take on different shapes, e.g., sinusoidal, square wave, sawtooth, etc. Further, the bridging filaments 40 may be disposed on one or both of the exterior and interior surfaces 38, 39 of the mask body 12 in a random pattern such that each bridging filament 40 takes on a unique shape.

Bridging filaments 40 may also be disposed in any suitable manner on the filtering structure 30. For example, in one or more embodiments, the bridging filaments 40 may be melt bonded to at least some of the peaks 34 of the filtering structure 30. In one or more embodiments, the bridging filaments 40 may be bonded to the filtering structure 30 such that the mask body 12 includes any suitable number of bonds per linear cm between the bridging filaments and the filtering structure. For example, in one or more embodiments, the mask body 12 can include at 0.5 bonds per linear cm between the bridging filaments 40 and the filtering structure 30. Further, in one or more embodiments, the mask body 12 can include no greater than 5 bonds per linear cm between the bridging filaments 40 and the filtering structure 30.

The mask body 12 can include any suitable number of bridging filaments 40. In one or more embodiments, the mask body 12 can include bridging filaments 40 that are substantially similar to each other, e.g., each bridging filament includes the same material or combination of materials, includes the same diameter, etc. In one or more alternative embodiments, the mask body 12 can include a variety of bridging filaments 40. In one or more embodiments, the mask body 12 can include a first set of bridging filaments and a second set of bridging filaments. For example, FIG. 6 is a schematic perspective view of one embodiment of a respirator 600. All of the design considerations and possibilities regarding the respirator 10 of FIGS. 1-3 apply equally to the respirator 600 of FIG. 6. The respirator 600 includes a mask body 612 that includes a corrugated filtering structure 630. The filtering structure 630 includes peaks 634 separated by valleys 636. The mask body 612 also includes bridging filaments 640 that are in discontinuous contact with an exterior surface 638 of the filtering structure 630. Respirator 600 also includes a nose clip 660 disposed adjacent a nose region 614 of the mask body 612. Further, the respirator 600 includes a harness 620 attached to the mask body 612.

One difference between respirator 10 and respirator 600 is that respirator 600 is a vertical flat fold respirator, whereas respirator 10 is a molded respirator. Another difference is that respirator 600 includes bridging filaments 640 that include a first set of bridging filaments 642 and a second set of bridging filaments 644, where the bridging filaments are disposed in a substantially vertical direction on the filtering structure 630 orthogonal to the crosswise direction of the respirator 600 (as viewed from the perspective of the wearer of the respirator when the wearer is in an upright position). Further, peaks 634 are substantially aligned with a peak axis 650 that extends in a crosswise direction relative to the mask body 612.

The first set of bridging filaments 642 can have the same properties and dimensions as the second set of bridging filaments 644. Alternatively, in one or more embodiments, the first set of bridging filaments 642 can be different from the second set of bridging filament 644. In one or more embodiments, the first set of bridging filaments 642 can include filaments having a first average diameter, and the second set of bridging filaments 644 can include filaments having a second average diameter that is different from the first average diameter. In one or more embodiments, the first set of bridging filament 642 can include filaments having from a first material, and the second set of bridging filaments 644 can include filaments having a second material different from the first material. Further, in one or more embodiments, the first set of bridging filament 642 can be disposed on the filtering structure 630 in a first pattern, and the second set of bridging filaments 644 can be disposed on the filtering structure in a second pattern different from the first pattern. For example, the first set of bridging filaments 642 can be disposed on the filtering structure 630 such that one or more filaments form a sinusoidal shape, and the second set of bridging filaments 644 can be disposed on the filtering structure such that one or more filaments form a straight line.

The first and second sets of bridging filaments 642, 644 can be disposed in any suitable pattern on the filtering structure 630 of the mask body 612. For example, filaments of the first set of filaments 642 can alternate with filaments of the second set of filaments 644. Alternatively, two or more filaments of the first set of bridging filament 642 can be disposed adjacent to each other, followed by two or more filaments of the second set of bridging filaments 644. Any suitable pattern between the first set of bridging filaments 642 and the second set of bridging filament 644 can be formed on the filtering structure 630 of the mask body 612.

The filtering structure can include any suitable layer or layers having any suitable construction. For example, FIG. 4 is a schematic cross-section view of a portion of a filtering structure 400 that can be utilized in the mask body 12 of respirator 10. The filtering structure 400 that is used in connection with respirators suitable for use with the present disclosure may take on a variety of different shapes and configurations. As shown in FIG. 4, the filtering structure 400 may have a plurality of layers, including a fibrous filtration layer 408, and one or more fibrous cover webs 402 (i.e., an inner cover web) and 404 (i.e., an outer cover web). When the respirator is a molded mask, the mask body may also include an optional shaping layer 406. See, e.g., U.S. Pat. No. 6,923,182 to Angadjivand et al.; U.S. Pat. No. 7,131,442 to Kronzer et al.; U.S. Pat. Nos. 6,923,182 and 6,041,782 to Angadjivand et al.; U.S. Pat. No. 4,807,619 to Dyrud et al.; and U.S. Pat. No. 4,536,440 to Berg. In general, the filtering structure removes contaminants from the ambient air and may also act as a barrier layer that precludes liquid splashes from entering the mask interior. The outer cover web 404 can act to stop or slow any liquid splashes, and the inner filtering structure 400 may then contain them if there is penetration past the other layers. The filtering structure 400 can be of a particle capture or gas and vapor type filter. The filtering structure 400 may include multiple layers of similar or dissimilar filter media and one or more cover webs as the application requires. In one or more embodiments, the respirator can contain a fluid impermeable mask body that has one or more filter cartridges attached to it. See, e.g., U.S. Pat. No. 6,874,499 to Viner et al.; U.S. Pat. No. 6,277,178 and D613,850 to Holmquist-Brown et al.; RE39,493 to Yuschak et al.; D652,507, D471,627, and D467,656 to Mittelstadt et al.; and D518,571 to Martin.

The cover webs 402, 404 may be located on the outer sides of the filtering structure 400 to capture any fibers that could come loose therefrom. Typically, the cover webs 402, 404 are made from a selection of fibers that provide a comfortable feel, particularly on a side 410 of the filtering structure 400 that makes contact with the wearer's face. The constructions of various filter layers, shaping layers, and cover webs that may be used in conjunction with a filtering structure used in a respirator of the present disclosure are described herein in more detail.

Filtration layers that may be beneficially employed in a respirator of the present disclosure are generally low in pressure drop (e.g., less than about 195 to 295 Pascals at a face velocity of 13.8 centimeters per second) to minimize the breathing work of the mask wearer. Filtration layers additionally are flexible and have sufficient shear strength so that they generally retain their structure under the expected use conditions. Examples of particle capture filters include one or more webs of fine inorganic fibers (such as fiberglass) or polymeric synthetic fibers. Synthetic fiber webs may include electret-charged polymeric microfibers that are produced from processes such as meltblowing. Polyolefin microfibers formed from polypropylene that has been electrically charged provide particular utility for particulate capture applications.

The filtration layer 408 is typically chosen to achieve a desired filtering effect. The filtration layer generally will remove a high percentage of particles and/or or other contaminants from the gaseous stream that passes through it. For fibrous filter layers, the fibers selected depend upon the kind of substance to be filtered and, typically, are chosen so that they do not become bonded together during the manufacturing operation. As indicated, the filtration layer may come in a variety of shapes and forms and typically has a thickness of about 0.2 millimeters (mm) to 1 centimeter (cm), more typically about 0.3 mm to 0.5 cm, and it could be a generally planar web or it could be corrugated to provide an expanded surface area. See, e.g., U.S. Pat. Nos. 5,804,295 and 5,656,368 to Braun et al. The filtration layer 408 also may include multiple filtration layers joined together by an adhesive or any other techniques. Essentially any suitable material that is known (or later developed) for forming a filtering layer may be used as the filtering material. Webs of melt-blown fibers, such as those taught in Wente, Van A., Superfine Thermoplastic Fibers, 48 Indus. Eng. Chem., 1342 et seq. (1956), especially when in a persistent electrically charged (electret) form are especially useful (see, e.g., U.S. Pat. No. 4,215,682 to Kubik et al.). These melt-blown fibers may be microfibers that have an effective fiber diameter less than about 20 micrometers (μm) (referred to as BMF for “blown microfiber”), typically about 1 to 12 μm. Effective fiber diameter may be determined according to Davies, C. N., The Separation Of Airborne Dust Particles, Institution Of Mechanical Engineers, London, Proceedings 1B, 1952. In one or more embodiments, the filtration layer can include one or more BMF webs that contain fibers formed from polypropylene, poly(4-methyl-1-pentene), and combinations thereof. Electrically charged fibrillated-film fibers as taught in U.S. Pat. Re. 31,285 to van Turnhout also may be suitable, as well as rosin-wool fibrous webs and webs of glass fibers or solution-blown, or electrostatically sprayed fibers, especially in microfiber form. Electric charge can be imparted to the fibers by contacting the fibers with water as disclosed in U.S. Pat. No. 6,824,718 to Eitzman et al.; U.S. Pat. No. 6,783,574 to Angadjivand et al.; U.S. Pat. No. 6,743,464 to Insley et al.; U.S. Pat. Nos. 6,454,986 and 6,406,657 to Eitzman et al.; and U.S. Pat. Nos. 6,375,886 and 5,496,507 to Angadjivand et al. Electric charge also may be imparted to the fibers by corona charging as disclosed in U.S. Pat. No. 4,588,537 to Klasse et al., or by tribocharging as disclosed in U.S. Pat. No. 4,798,850 to Brown. Also, additives can be included in the fibers to enhance the filtration performance of webs produced through the hydro-charging process (see U.S. Pat. No. 5,908,598 to Rousseau et al.). Fluorine atoms, in particular, can be disposed at the surface of the fibers in the filter layer to improve filtration performance in an oily mist environment. See, e.g., U.S. Pat. Nos. 6,398,847 B1, 6,397,458 B1, and 6,409,806 B1 to Jones et al. Typical basis weights for electret BMF filtration layers are about 10 to 100 grams per square meter (g/m²). When electrically charged according to techniques described in, e.g., the '507 Angadjivand et al. patent, and when including fluorine atoms as mentioned in the Jones et al. patents, the basis weight may be about 20 to 40 g/m² and about 10 to 30 g/m², respectively. Additionally, sorptive materials such as activated carbon may be disposed between the fibers and/or various layers that include the filtering structure. Further, separate particulate filtration layers may be used in conjunction with sorptive layers to provide filtration for both particulates and vapors. The sorbent component may be used for removing hazardous or odorous gases from the breathing air. Sorbents may include powders or granules that are bound in a filter layer by adhesives, binders, or fibrous structures. See, e.g., U.S. Pat. No. 6,334,671 to Springett et al. and U.S. Pat. No. 3,971,373 to Braun. A sorbent layer can be formed by coating a substrate, such as fibrous or reticulated foam, to form a thin coherent layer. Sorbent materials may include activated carbons that are chemically treated or not, porous alumna-silica catalyst substrates, and alumna particles. An example of a sorptive filtering structure that may be conformed into various configurations is described in U.S. Pat. No. 6,391,429 to Senkus et al.

The cover webs also may have filtering abilities, although typically not nearly as good as the filtering layer and/or may serve to make a filtering face-piece respirator more comfortable to wear. The cover webs may be made from nonwoven fibrous materials such as spun bonded fibers that contain, e.g., polyolefins, and polyesters. See, e.g., U.S. Pat. No. 6,041,782 to Angadjivand et al.; U.S. Pat. No. 4,807,619 to Dyrud et al.; and U.S. Pat. No. 4,536,440 to Berg. When a wearer inhales, air is drawn through the mask body, and airborne particles become trapped in the interstices between the fibers, particularly the fibers in the filter layer.

The inner cover web 402 to can be used to provide a smooth surface for contacting the wearer's face. Further, the outer cover web 404, in addition to providing splash fluid protection, can be used for entrapping loose fibers in the mask body and for aesthetic reasons. The cover web typically does not provide any substantial filtering benefits to the filtering structure, although it can act as a pre-filter when disposed on the exterior of (or upstream to) the filtration layer. To obtain a suitable degree of comfort, an inner cover web can have a comparatively low basis weight and can be formed from comparatively fine fibers. More particularly, in one or more embodiments, the cover web may be fashioned to have a basis weight of about 5 to 70 g/m² (typically 10 to 30 g/m²), and the fibers may be less than 3.5 denier (typically less than 2 denier, and more typically less than 1 denier but greater than 0.1 denier). Fibers used in the cover web often have an average fiber diameter of about 5 to 24 micrometers, typically of about 7 to 18 micrometers, and more typically of about 8 to 12 micrometers. The cover web material may have a degree of elasticity (typically, but not necessarily, 100 to 200% at break) and may be plastically deformable.

Suitable materials for the cover web may be blown microfiber (BMF) materials, particularly polyolefin BMF materials, e.g., polypropylene BMF materials (including polypropylene blends and also blends of polypropylene and polyethylene). And an exemplary process for producing BMF materials for a cover web is described in U.S. Pat. No. 4,013,816 to Sabee et al. The web may be formed by collecting the fibers on a smooth surface, typically a smooth-surfaced drum or a rotating collector. See, e.g., U.S. Pat. No. 6,492,286 to Berrigan et al. Spun-bond fibers also may be used.

A typical cover web may be made from polypropylene or a polypropylene/polyolefin blend that contains 50 weight percent or more polypropylene. These materials have been found to offer high degrees of softness and comfort to the wearer and also, when the filter material is a polypropylene BMF material, to remain secured to the filter material without requiring an adhesive between the layers. Polyolefin materials that are suitable for use in a cover web may include, for example, a single polypropylene, blends of two polypropylenes, and blends of polypropylene and polyethylene, blends of polypropylene and poly(4-methyl-1-pentene), and/or blends of polypropylene and polybutylene. One example of a fiber for the cover web is a polypropylene BMF made from the polypropylene resin “Escorene 3505G” from Exxon Corporation, providing a basis weight of about 25 g/m² and having a fiber denier in the range 0.2 to 3.1 (with an average, measured over 100 fibers of about 0.8). Another suitable fiber is a polypropylene/polyethylene BMF (produced from a mixture comprising 85% of the resin “Escorene 3505G” and 15 percent of the ethylene/alpha-olefin copolymer “Exact 4023” also from Exxon Corporation) providing a basis weight of about 25 g/m² and having an average fiber denier of about 0.8. Suitable spunbond materials are available under the trade designations “Corosoft Plus 20,” “Corosoft Classic 20” and “Corovin PP S 14,” from Corovin GmbH of Peine, Germany, and a carded polypropylene/viscose material available, under the trade designation “370/15,” from J. W. Suominen O Y of Nakila, Finland. Cover webs typically have very few fibers protruding from the web surface after processing and therefore have a smooth outer surface. Examples of cover webs that may be used in a respirator of the present disclosure are described, e.g., in U.S. Pat. No. 6,041,782 to Angadjivand; U.S. Pat. No. 6,123,077 to Bostock et al.; and PCT Publication No. WO 96/28216A to Bostock et al.

In one or more embodiments, one or both of the inner cover web 402 and outer cover web 404 can include a polymeric netting. Any suitable polymeric netting described herein can be utilized for one or both cover webs. The netting may be made from a variety of polymeric materials. Polymers suitable for netting formation are thermoplastic materials. Examples of thermoplastic polymers that can be used to form polymer netting of the present invention include polyolefins (e.g., polypropylene and polyethylene), polyethylene-vinyl acetate (EVA), polyvinyl chloride, polystyrene, nylons, polyesters (e.g., polyethylene terephthalate), and elastomeric polymers, (e.g., ABA block copolymers, polyurethanes, polyolefin elastomers, polyurethane elastomers, metallocene polyolefin elastomers, polyamide elastomers, ethylene vinyl acetate elastomers, and polyester elastomers). Blends of two or more materials also may be used in the manufacture of nettings. Examples of such blends include polypropylene/EVA and polyethylene/EVA. Polypropylene may be preferred for use in the polymeric netting since melt-blown fibers are regularly made from polypropylene. Use of similar polymers enables proper welding of the support structure to the filtering structure.

The optional shaping layer(s) may be formed from at least one layer of fibrous material that can be molded to the desired shape with the use of heat and that retains its shape when cooled. Shape retention is typically achieved by causing the fibers to bond to each other at points of contact between them, for example, by fusion or welding. Any suitable material known for making a shape-retaining layer of a direct-molded respiratory mask may be used to form the mask shell, including, for example, a mixture of synthetic staple fiber, e.g., crimped, and bicomponent staple fiber. Bicomponent fiber is a fiber that includes two or more distinct regions of fibrous material, typically distinct regions of polymeric materials. Typical bicomponent fibers include a binder component and a structural component. The binder component allows the fibers of the shape-retaining shell to be bonded together at fiber intersection points when heated and cooled. During heating, the binder component flows into contact with adjacent fibers. The shape-retaining layer can be prepared from fiber mixtures that include staple fiber and bicomponent fiber in weight-percent ratios that may range, for example, from 0/100 to 75/25. In one or more embodiments, the material includes at least 50 weight-percent bicomponent fiber to create a greater number of intersection bonding points, which, in turn, increase the resilience and shape retention of the shell.

Suitable bicomponent fibers that may be used in the shaping layer include, for example, side-by-side configurations, concentric sheath-core configurations, and elliptical sheath-core configurations. One suitable bicomponent fiber is the polyester bicomponent fiber available, under the trade designation “KOSA T254” (12 denier, length 38 mm), from Kosa of Charlotte, N.C., U.S.A., which may be used in combination with a polyester staple fiber, for example, that is available from Kosa under the trade designation “T259” (3 denier, length 38 mm) and possibly also a polyethylene terephthalate (PET) fiber, for example, that available from Kosa under the trade designation “T295” (15 denier, length 32 mm). Alternatively, the bicomponent fiber may include a generally concentric sheath-core configuration having a core of crystalline PET surrounded by a sheath of a polymer formed from isophthalate and terephthalate ester monomers. The latter polymer is heat softenable at a temperature lower than the core material. Polyester has advantages in that it can contribute to mask resiliency and can absorb less moisture than other fibers.

Alternatively, the optional shaping layer can be prepared without bicomponent fibers. For example, fibers of a heat-flowable polyester can be included together with, e.g., stapled, crimped, fibers in a shaping layer so that, upon heating of the web material, the binder fibers can melt and flow to a fiber intersection point where it forms a mass that upon cooling of the binder material, creates a bond at the intersection point. Staple fibers (for the shaping component) that are pre-treated with Ammonium Polyphosphate-type intumescent FR agents may be used in connection with the present disclosure in addition to or in lieu of a spray-application of the agent. Having the staple fibers contain, or, otherwise being treated with, the agent and then formed into a shell (using binder fibers to hold it together) would be another pathway to employ the agents.

When a fibrous web is used as the material for the shape-retaining shell, the web can be conveniently prepared on a “Rando Webber” air-laying machine (available from Rando Machine Corporation, Macedon, N.Y.) or a carding machine. The web can be formed from bicomponent fibers or other fibers in conventional staple lengths suitable for such equipment. To obtain a shape-retaining layer that has the required resiliency and shape-retention, the layer can have a basis weight of at least about 100 g/m², although lower basis weights are possible. Higher basis weights, for example, approximately 150 or more than 200 g/m², may provide greater resistance to deformation and greater resiliency and may be more suitable if the mask body is used to support an exhalation valve. Together with these minimum basis weights, the shaping layer typically has a maximum density of about 0.2 g/cm² over the central area of the mask. Typically, the shaping layer would have a thickness of about 0.3 to 2.0, more typically about 0.4 to 0.8 millimeters. Examples of shaping layers suitable for use in the present disclosure are described, e.g., U.S. Pat. No. 5,307,796 to Kronzer et al.; U.S. Pat. No. 4,807,619 to Dyrud et al.; and U.S. Pat. No. 4,536,440 to Berg. Staple fibers (for the shaping component) that are pre-treated with Ammonium Polyphosphate-type intumescent FR agents may be used in connection with the present disclosure in addition to or in lieu of a spray-application of the agent. Having the staple fibers contain, or, otherwise being treated with, the agent and then formed into a shell (using binder fibers to hold it together) would be another pathway to employ the agents.

As mentioned herein, the various embodiments of respirators described herein can include any suitable elements or features that add various functions to the respirators. For example, FIG. 5 is a schematic plan view of one embodiment of a respirator 500. All of the design considerations and possibilities regarding the respirator 10 of FIGS. 1-3 apply equally to the respirator 500 of FIG. 5. The respirator 500 includes a mask body 512 that includes a corrugated filtering structure 530 having peaks 534 separated by valleys 536. The mask body 512 also includes bridging filaments 540 that are in discontinuous contact with an exterior surface 538 of the filtering structure 530.

One difference between respirators 10 and 500 is that respirator 500 is a flat fold respirator, whereas respirator 10 is a molded respirator. One additional difference is that respirator 500 includes a valve 570 disposed on the exterior surface 538 of the filtering structure 530. Any suitable valve 570 can be included with respirator 500. Further, the valve 570 can be disposed in any suitable location on the mask body 512.

Unlike the respirator 10 where the bridging filaments 40 are disposed on the filtering structure 30 in a crosswise direction on the filtering structure, the bridging filaments 540 of respirator 500 are disposed in a substantially vertical direction orthogonal to the crosswise direction of the respirator (as viewed from the perspective of the wearer of the respirator when the wearer is in an upright position). Further, peaks 534 are substantially aligned with a peak axis 550 that extends in a crosswise direction relative to the mask body 512.

Returning to the FIGS. 1-3, the respirator 10 can include any suitable additional layers and elements. For example, a carbon layer (not shown) can be attached to the bridging filaments 40 on the exterior surface 38 of the filtering structure such that the filaments are disposed between the carbon layer and the filtering structure. Such carbon layer can provide additional filtering of ambient air. Any suitable technique or combination of techniques can be utilized to attach the carbon layer to the bridging filaments 40. For example, the carbon layer can be attached to the bridging filaments 40 when the filaments are still tacky from being extruded or melt-bonded onto the filtering structure 30.

Respirator 10 can be corrugated or pleated using any suitable technique or combination of techniques by which peaks 34 and valleys 36 may be formed in the filtration layer 30 prior to bridging filaments 40 being disposed on the filtering structure 30. For example, in one or more embodiments, the filtering structure 30 can be sent through a set of corrugating gears, e.g., in any suitable variation of the techniques disclosed, e.g., in U.S. Pat. No. 5,256,231 to Gorman et al. Bridging filaments 40 may be bonded to any suitable number of peaks of the filtering structure 30 by any suitable technique. If the filaments 40 are provided as a pre-existing scrim or netting, such netting can be applied, e.g., to the filtering structure 30, and bonded to at least some of the peaks thereof, by any suitable technique. For example, a netting may be obtained e.g. as a continuous roll, a bonding adhesive can be applied thereto (e.g., by coating the adhesive onto at least some surfaces of filaments 30 of the netting), and the netting then contacted with the filtering structure 30 so as to cause bonding between adhesive-coated portions of the filament and portions of the peaks that they are contacted with.

Other bonding techniques (e.g., ultrasonic bonding, melt-bonding (including e.g. heat-sealing), and so on), are also possible. In embodiments in which filaments 40 are not provided as part of a pre-existing netting, they may be melt-extruded onto the peaks of the filtering structure, e.g., while the media is still resident on a corrugating (pleating) gear or any other kind of corrugating apparatus. Such techniques could be any suitable variation of the techniques disclosed, e.g., in U.S. Pat. No. 5,256,231 to Gorman et al.; U.S. Pat. No. 5,620,545 to Braun et al.; and U.S. Pat. No. 7,052,565 to Seth. In embodiments in which filaments 40 are melt-bonded onto one or more peaks 34 of the filtering structure 30, the composition of filaments and the fibers of the filtering structure (specifically, the outermost fibers of media 10, if media 10 includes multiple layers) may be chosen to facilitate such melt-bonding. For example, the filaments 40 and fibers of the filtering structure 30 may be made of materials that are sufficiently compatible to allow melt-bonding to occur. In one or more embodiments, filaments 40 and the fibers of filtering structure 30 may include the same type of polymer (e.g., they may both be polypropylene, poly (lactic acid), etc.). It will be noted that in some circumstances (e.g., when the filaments 40 are melt-extruded onto one or more of the peaks 34) some penetration of the molten filament material into the spaces between the fibers of filtering structure 30 may occur, which may augment the bonding process by achieving at least some physical entanglement or entrapment.

However provided, in one or more embodiments, filaments 40 may be provided generally across the entire length or width of the corrugated filtering structure 30. The corrugated filtering structure 30 may be trimmed or cut to the desired final length and/or width before or after the bonding of the filaments thereto, as desired.

FIG. 7 schematically illustrates a method and apparatus 700 for making a respirator (e.g., respirator 10 of FIGS. 1-3) in accordance with one embodiment of the present disclosure. The apparatus 700 may receive a filtering structure web (e.g., filtering structure 400 of FIG. 4).

The filtering structure 710 is run through first and second corrugating members 720, 721 to form a corrugated filtering structure. The corrugating members 720, 721 may be generally cylindrical rollers each having parallel axes of rotation and a multiplicity of ridges or teeth 722 along their respective peripheries. The teeth 722 have spaces therebetween operable to receive the teeth 722 of the other corrugating member along a meshing portion 712.

A motor or other device may be used to rotate the members 720, 721 so that when the filtering structure 710 is fed between the meshing portion 712 of the teeth 722, the filtering structure generally conforms to the periphery of the members to form arcuate portions in the spaces between the teeth of the first corrugating member 720, and anchor portions 712 along the outer surfaces of the teeth of the first corrugating member. Prior to attaching bridging filaments to the corrugated filtering structure, the filtering structure can be formed into a cup-shaped configuration.

The apparatus 700 depicted in FIG. 7 also includes an extruder die 730 operable to feed a user-selectable die tip 732. The die tip 732 may include spaced openings (not shown) for extruding strand material (e.g., polyester, polystyrene, polyolefin, nylons, coextruded materials or the like) to form numerous, elongate molten filament 714 of material.

Once solidified, the filaments 714 are formed as illustrated in FIG. 7. After solidification, the filaments 714 may exhibit elastic or inelastic properties. The die tip 732 is operable to position the molten filaments 714 onto the peaks (e.g., peaks 34 of FIGS. 1-3) of corrugated filtering structure.

Each of the filaments 714 may be formed by extruding a generally constant volumetric flow from the filament die tip 732 onto the filtering structure, which can move at a constant rate of speed. That is, a constant linear volume of filament material may flow to form each filament 714. As a result, filament 714 may have a generally uniform volume of filament material along their lengths (even though the cross-sectional profile of the filament 714 may change along its length as described herein). Furthermore, the filaments 714 may all be formed with the same dimensions, although in some embodiments filaments may be formed with different dimensions, e.g., some filaments may be thicker or thinner than adjacent filaments.

The dimensions of the filaments may be easily varied by changing the pressure in the extruder die 730 (e.g., by changing the extruder screw speed or type); changing the speed at which the first corrugating member 720, and thereby the filtering structure 710, is moved (i.e., for a given rate of output from the extruder die 730, increasing the speed at which the structure 710 is moved will decrease the diameter of the filaments 714, whereas decreasing the speed at which the structure 710 is moved will increase the diameter of the filaments 714); changing the dimensions of the spaced die openings, etc.

The filament die tip 732 may be easily interchangeable such that filaments 714 of different configurations, e.g., different diameters and different spacing, can be formed. Selectively adjustable spacing and/or diameters for the openings along the length of the filament die tip 732 may, for example, allow change in filament strength at various locations across the structure 710, and/or change in anchorage of the structure 710 to the filaments 714. The filament die tip 732 may also be selected to form filaments of other configurations, e.g., hollow strands, strands with shapes other than round (e.g., square, rectangular, oval, triangular, star, “+” shaped, etc.), or bi-component strands.

In one or more embodiments, an extruder and die may not be provided. The elongate filaments 714 may be pre-formed and fed into the nip formed by the first corrugating member 720 and the second corrugating member 721. One or both of the corrugating members 720, 721 may be heated so that the pre-formed filaments 714 are softened or melted and attached to the peaks as described herein. Alternatively, preformed filaments may be provided after the structure 710 has passed through corrugating member 720, 721, with attachment being performed using a different roll positioned to form a nip opposite, e.g. corrugating roll 720. These preformed filaments can be used in any of the contemplated embodiments of the invention where filaments are provided by extrusion.

A cooling apparatus, e.g., a generally cylindrical cooling roller 740 powered for rotation about a rotational axis parallel with the axis of the corrugating members 720, 721, may also be provided. The periphery of the cooling roller 740 may be closely spaced from and define a nip with the periphery of the first corrugating member 720 at the predetermined distance from the meshing portion 712 of the teeth 722.

A nip roll 742 for holding the corrugated filtering structure 716 on the cooling roller 740 for a predetermined distance around its periphery may also be provided. Prolonged contact with the cooling roller 740 may permit the filaments 714 to more effectively cool and solidify before undergoing subsequent processes.

A severing device 750 may preferably be included in apparatus 700. The severing device 750 may sever the strands of material 714.

### EXAMPLES

Corrugated composite filters were prepared on a three-roll embossing and laminating machine that was similar to apparatus 700 of FIG. 7. The corrugation was accomplished by passing one or more input webs between mated, heated, corrugated rolls; maintaining the corrugated web in the corrugation recesses of corrugated roll; extruding a plurality of continuous polymer strands from a strand die; bringing the continuous polymer strands into contact with the corrugated web; pressing the polymer strands onto the surface of the corrugated web peaks with a smooth roll while still in a partially molten state; and optionally adding a flat top scrim, e.g., a smooth BMF scrim including a low fiber diameter BMF blown onto a smooth roll collector as described in U.S. Pat. No. 5,496,507 to Angdajivand et al.

For the Macrodrop utilized in the Examples, the meltblown fibers were formed from a 100 melt flow polypropylene available under the designation Total Polypropylene 3860X, (available from Total Petrochemicals USA, INC. Houston, Tex.), to which had been added 3% wt. % pigment, product number: CC10054018WE (available from PolyOne Corporation, Elk Grove, Ill.) as a colorant. The polymer was fed to a Model 20 DAVIS STANDARD™ 2 in. (50.8 mm) single screw extruder (available from the Davis Standard Division of Crompton & Knowles Corp, Pawcatuck, Conn.). The extruder had a 20/1 length/diameter ratio and a 3/1 compression ratio. A Zenith 10 cc/rev melt pump metered the flow of polymer to a 50.8 cm wide drilled orifice meltblowing die. The die, which originally contained 0.3 mm diameter orifices, had been modified by drilling out every 9th orifice to 0.6 mm, thereby providing a 9:1 ratio of the number of smaller size to larger size holes and a 2:1 ratio of larger hole size to smaller hole size. This die design served to deliver a nominal ratio of total larger-diameter fiber extrudate to total smaller-diameter fiber extrudate of approximately 60/40 by volume. The line of orifices had 10 holes/cm hole spacing. Heated air was used to attenuate the fibers at the die tip. The airknife was positioned at a 0.5 mm negative set back from the die tip and a 0.76 mm air gap. No to moderate vacuum was pulled through a medium mesh collector screen at the point of web formation. The polymer output rate from the extruder was about 0.18 kg/cm/hr, the DCD (die-to-collector distance) was about 53 cm, and the air pressure was adjusted as desired. A web with the following properties was produced by adjusting the process. A flow rate of 32 lpm was used to measure the pressure drop and calculate the EFD (Effective Fiber Diameter) and Solidity. The resulting microdrop had the following characteristics: DP=0.36 mm H₂O; basis weight=1.04 g/5¼″ circle (74 gsm); EFD=21 microns; thickness=39 mil (0.99 mm); and solidity=8.3%.

A staple fiber addition unit was then started and combination web was formed including meltblown fibers made according to the above conditions, and also including staple fibers introduced into the meltblown fiber stream. The staple fibers included a 15 denier polyester Bico fiber product available under the designation trade name STEIN 15D BICO (available from Stein Fiber Ltd, Spartanburg, S.C.), and were introduced so as to form a bimodal fiber mixture web including approximately 50% by weight meltblown fibers and 50% by weight staple fibers. The combination web properties after adding the staple fiber as follows: DP=0.20 mm H₂O; basis weight=2.14 g/13.34 cm circle (153 gsm); EFD=28 microns; thickness=200 mil (5.1 mm); and solidity=3.0%.

### Example 1

Blown Microfiber (BMF) web was prepared using a 100 MFI polypropylene according to the techniques described in U.S. Pat. No. 5,496,507 to Angdajivand et al. The BMF web and a plenum web (carded web with 50% bico-PET staple fiber and 50% PET staple fiber) were run through the corrugating apparatus (e.g., similar to apparatus 700 of FIG. 7) with both 1.18 peaks per linear cm and 0.29 peaks per linear cm corrugating patterns. Polymer filaments made from Total 5571 polypropylene (available from Total Petrochemicals USA, INC. Houston, Tex.), were added to the construction at density of 1.6 filaments per cm in the cross-web dimension. The filament diameter in the final corrugated filtering structure was 0.4-0.5 mm. The corrugated filtering structure had 0.78 bonds per cm between the filaments and the filtering structure.

The corrugated filtering structure was tested with 2% NaCl at 85 lpm using a TSI 8130 (available from TSI Inc., Shoreview, Minn.). Two BMF webs with different Effective Fiber Diameters (EFDs) (4.7 and 8 Micron) were used. The EFD of a web is evaluated according to the techniques set forth in Davies, C. N., The Separation of Airborne Dust and Particles, Institution of Mechanical Engineers, London, Proceedings 1B, 1952. Unless otherwise noted, the test is run at a face velocity of 14 cm/sec. The results are listed in Table 1 below:

TABLE 1
Flat vs Corrugated Filter Performance
2% NaCl Test @ 85 lpm

| Type of filtering | PD | Pen | PD | Pen |
|---|---|---|---|---|
| structure | mmH2O | % | mmH2O | % |
| 13.34 cm | 4.7 EFD | 4.7 EFD | 8 EFD | 8 EFD |
| diameter | BMF + | BMF + | BMF + | BMF + |
| Circle Sample | Plenum | Plenum | Plenum | Plenum |
| Flat filtering | 9.6 | 2.99 | 5.6 | 0.538 |
| structure | | | | |
| 0.78 bonds/cm | 5.1 | 1.23 | 3.2 | 0.212 |

As can be seen from Table 1, when both 4.7 and 8 EFD BMF filters are laminated with plenum web, after corrugation the pressure drop and penetration improve by nearly a factor of 2.

Pressure drop and percent penetration may be determined using a challenge aerosol containing NaCl or DOP particles, delivered (unless otherwise indicated) at a flow rate of 95 or 85 liters/min, and evaluated using a TSI™ Model 8130 high-speed automated filter tester (available from TSI Inc., Shoreview, Minn.). An MKS pressure transducer (available from MKS Instruments, Andover, Mass.) may be employed to measure pressure drop (ΔP, mm H2O) through the filter. For NaCl testing at 95 liters/min, the particles may be generated from a 1% NaCl solution, and the Automated Filter Tester may be operated with both the heater and particle neutralizer on. For NaCl testing at 85 liters/min and using 0.075 μm diameter particles, the particles may be generated from a 2% NaCl solution to provide an aerosol containing particles at an airborne concentration of about 16-23 mg/m³, and the Automated Filter Tester may be operated with both the heater and particle neutralizer on. For DOP testing, the aerosol may contain particles with a diameter of about 0.185 μm at a concentration of about 100 mg/m³, and the Automated Filter Tester may be operated with both the heater and particle neutralizer off. The samples may be loaded to the maximum NaCl or DOP particle penetration and calibrated photometers may be employed at the filter inlet and outlet to measure the particle concentration and the % particle penetration through the filter.

### Example 2

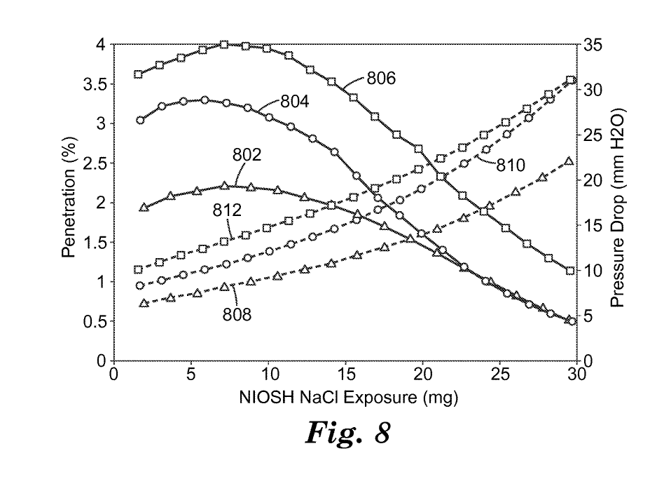

In this example, a 4.7 EFD BMF was laminated to Plenum and Macrodrop webs and the laminated webs were corrugated as described in Example 1 such that they included either a 0.78 or 1.18 bond/cm corrugation. The initial pressure drop and penetration test results are shown in Table 2 and the loading results are shown in FIG. 8.

TABLE 2
Flat vs Corrugated Filter Performance
2% NaCl Test @ 85 lpm
13.34 cm Circle Sample

| | DP | Penetration |
|---|---|---|
| Samples | mm H2O | % |
| 0.78 Bond/cm Corrugated | 6.4 | 1.93 |
| 4.7 EFD + Plenum | | |
| 1.18 Bond/cm Corrugated | 8.3 | 3.04 |
| 4.7 EFD + Macrodrop | | |
| Flat Web | 10.1 | 3.62 |
| 4.7 EFD + Plenum | | |

In FIG. 8, curves 802 and 808 represent a 0.78 bond per cm corrugated filtering structure laminated to a plenum, curves 804 and 810 represent a 1.18 bond per cm corrugated filtering structure laminated to a macro drop, and curves 806 and 812 represents a flat web laminated to a plenum. Curves 802, 804, and 806 illustrate the percent penetration using a 9-sodium chloride exposure test. Further, curves 808, 810, and 812 illustrate pressure drop in millimeters of H₂O. Penetration and pressure drop for individual samples were determined by using an AFT Tester, Model 8130 (available from TSI Incorporated, Shoreview, Minn.). Sodium Chloride (NaCl) at a concentration of 20 milligrams per cubic meter (mg/m³) was used as a challenge aerosol. The aerosol challenge was delivered at a face velocity of 13.8 centimeters per second (cm/sec), corresponding to 85 liters per minute flow rate. Pressure drop over the sample (13.34 cm diameter circle sample) was measured during the penetration test and recorded in millimeters of water (mm H₂O). In particular, the pressure drop at 30 mg salt loading was reported.

Once again, a drop in penetration and a pressure drop can be seen in both cases when compared with the flat web sample in Table 2.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

What is claimed is:

1. A filtering face-piece respirator comprising a mask body and a harness attached to the mask body, wherein the mask body comprises:
a corrugated filtering structure comprising peaks separated by valleys; and
elastic bridging filaments that are in discontinuous contact with at least one of an interior surface and an exterior surface of the corrugated filtering structure, wherein the elastic bridging filaments are attached to at least some of the peaks.

2. The respirator of claim 1, wherein portions of the elastic bridging filaments are melt bonded to at least some of the peaks.

3. The respirator of claim 1, wherein the peaks extend along a peak axis, and further wherein at least some of the elastic bridging filaments are substantially perpendicular to the peak axis.

4. The respirator of claim 1, wherein an average filament spacing of the elastic bridging filaments is greater than 0 mm and no greater than 51 mm.

5. The respirator of claim 1, wherein the corrugated filtering structure comprises a nonwoven web comprising organic polymeric fibers.

6. The respirator of claim 1, wherein the peaks and the valleys of the corrugated filtering structure comprise an average radius of curvature of at least 2 mm.

7. The respirator of claim 1, wherein the corrugated filtering structure comprises a peak frequency of greater than 0 peaks per cm and no greater than 3 peaks per cm.

8. The respirator of claim 1, wherein the corrugated filtering structure comprises an average peak height of greater than 0 mm and no greater than 20 mm.

9. The respirator of claim 1, wherein the mask body does not comprise any permanently deformable layer or member that is corrugated along with the corrugated filtering structure so as to be in generally continuous contact with the corrugated filtering structure.

10. The respirator of claim 1, wherein the elastic bridging filaments are disposed on the exterior surface of the corrugated filtering structure.

11. The respirator of claim 1, wherein the corrugated filtering structure comprises an electrostatically charged material.

12. The respirator of claim 1, wherein the elastic bridging filaments are bonded to the corrugated filtering structure such that the mask body comprises at least 0.5 bonds per cm between the elastic bridging filaments and the corrugated filtering structure.

13. The respirator of claim 1, wherein the elastic bridging filaments comprise a material selected from the group consisting of polypropylene, polystyrene, polyethylene, polyurethane, SEBS, SEPS, SBPS, metallocene, KRATON, carbon, and combinations thereof.

14. The respirator of claim 1, wherein the elastic bridging filaments comprise an average diameter of at least 0.25 mm and no greater than 2.00 mm.

15. The respirator of claim 1, wherein the peaks of the corrugated filtering structure extend along a peak axis, and wherein at least some of the elastic bridging filaments are disposed at an angle of about 45 degrees to the peak axis.

16. The respirator of claim 1, wherein a carbon coating is disposed on at least some of the elastic bridging filaments.

17. The respirator of claim 1, wherein the elastic bridging filaments are disposed on both the exterior surface and the interior surface of the corrugated filtering structure.

18. The respirator of claim 1, wherein the elastic bridging filaments comprise a first set of filaments and a second set of filaments, wherein the elastic bridging filaments are disposed on the corrugated filtering structure such that the first set of filaments alternate with the second set of filaments across the filtering structure, wherein the first set of filaments comprises a first average diameter and the second set of filaments comprises a second average diameter, and further wherein the first average diameter is greater than the second average diameter.

19. A method of making a respirator comprising a mask body, the method comprising:
forming a filtering structure;
corrugating the filtering structure such that the filtering structure comprises peaks separated by valleys;
forming the corrugated filtering structure into a cup-shaped configuration to form the mask body;
attaching elastic bridging filaments to at least some of the peaks of the corrugated filtering structure such that the elastic bridging filaments are in discontinuous contact with at least one of an interior surface and an exterior surface of the corrugated filtering structure; and
attaching a harness to the mask body.

20. The method of claim 19, wherein attaching elastic bridging filaments comprises:
extruding the elastic bridging filaments as a molten extrudate; and
depositing the molten extrudate on at least one of the interior surface and the exterior surface of the corrugated filtering structure.
